(19) United States
(12) Patent Application Publication
(10) Pub. No.: US 2007/0267337 A1
(43) Pub. Date: Nov. 22, 2007

(54) FILTER ASSEMBLY

(76) Inventor: Jhu Cing Yang, Hsinchu City (TW)

Correspondence Address: PATENTTM.US, P. O. BOX 82788, PORTLAND, OR, 97282-0788, US

(21) Appl. No.: 11/746,846

(22) Filed: May 10, 2007

(30) Foreign Application Priority Data
May 17, 2006 (TW) 095117534

(51) Int. Cl. B01D 29/00

(52) U.S. Cl. 210/338; 210/497.01; 166/227; 166/236

(57) ABSTRACT

A filter assembly has a housing and a filter. The housing has a base, a cover with a outlet, an outer filter screen being tubular, an inner filter screen being tubular and a metal net being tubular. Lower edges and upper edges of the outer filter screen, the inner filter screen and metal net are respectively fastened on the base and the cover. The inner filter screen is surrounded by the outer filter screen. The metal net is surrounded by the inner filter screen. The filter is mounted between the outer filter screen and the inner filter screen and fitters impurities even with small dimension. Thus, the filter assembly will remove the impurities clearly to prevent a cylinder and a piston in an internal combustion engine from being rubbed.

### BACKGROUND OF THE INVENTION

1. Field of Invention

The present invention relates to a filter assembly, and more particularly to a filter assembly that is mounted in an internal combustion engine and comprises ceramic materials to filter fuel oils or exhaust gas to remove impurities.

2. Description of the Related Art

As mechanical industry develops, resources are almost exhausted and environment is contaminated. Especially in automobile industry, automobiles discharge exhaust gas with dark smoke to pollute the air. Thus, a filter is mounted in an exhaust pipe in each automobile to filter the exhaust gas.

An internal combustion engine is usually used in an automobile or a power machine. The internal combustion engine comprises a cylinder, a piston and other elements. Before the internal combustion engine is operated, fuel oils mixed with lubricant (ex. engine oil) from a fuel tank will be sprayed into the cylinder to be burned and to generate energy. When the internal combustion engine is operated, the cylinder and the piston or other elements will rub against each other. Thus, the lubricant can decrease friction between the cylinder and the piston or other elements.

However, the fuel oils have impurities that may deposit in the oil tank. The impurities will flow into the cylinder to rub against and damage the cylinder and the piston. Therefore, the internal combustion engine further has a filter to filter the impurities in the fuel oils and the lubricant before entering the cylinder, otherwise, the cylinder, the piston and other elements will be rubbed by the impurities.

With reference to FIG. 7, a conventional filter assembly has a metal net (40) and a filter paper (50). The metal net (40) is cylindrical and has multiple holes (41) to allow fuel oils and lubricant to pass through the holes (41). The filter paper (50) is hollow cylindrical, surrounds the metal net (40) and has multiple folds (51) and meshes. The folds can increase an area of the filter paper (50) contacting the fuel oils and the lubricant. The meshes allow the fuel oils and the lubricant to pass through the filter assembly, filter impurities in the fuel oils and the lubricant and each have a dimension.

However, the dimension of each mesh is too big for some small impurities, so that the filter paper (50) can not filter the small impurities. In addition, the fuel oils and the lubricant will wet and damage the filter paper (50), so the impurities will flow into the cylinder to wear the cylinder and the piston. In brief the filter made of paper can not have a good filtering effect.

To overcome the shortcomings, the present invention provides a filter assembly of an internal combustion engine to mitigate or obviate the aforementioned.

### SUMMARY OF THE INVENTION

The primary objective of the present invention is to provide a filter assembly that is mounted in an internal combustion engine and comprises ceramic materials to filter fuel oils or exhaust gas to remove impurities.

To achieve the objective, the filter assembly in accordance with the present invention has a housing and a filter. The housing has a base, a cover with a outlet, an outer filter screen being tubular, an inner filter screen being tubular and a metal net being tubular. Lower edges and upper edges of the outer filter screen, the inner filter screen and metal net are respectively fastened on the base and the cover. The inner filter screen is surrounded by the outer filter screen. The metal net is surrounded by the inner filter screen. The filter is mounted between the outer filter screen and the inner fitter screen and filters impurities even with small dimension. Thus, the filter assembly will remove the impurities clearly to prevent a cylinder and a piston in an internal combustion engine from being rubbed.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a filter of a filter assembly in accordance with the present invention;

FIG. 2 is an exploded perspective view of the filter assembly in FIG. 1;

FIG. 3 is a cross sectional side view of the filter assembly in FIG. 1;

FIG. 4 is a perspective view in partial section of the filter assembly in FIG. 1;

FIG. 5 is a perspective view of a second embodiment of a filter of a filter assembly in accordance with the present invention;

FIG. 6 is an exploded perspective view of the filter assembly in FIG. 5; and

FIG. 7 is an exploded perspective view of a conventional filter assembly in accordance with the prior art.

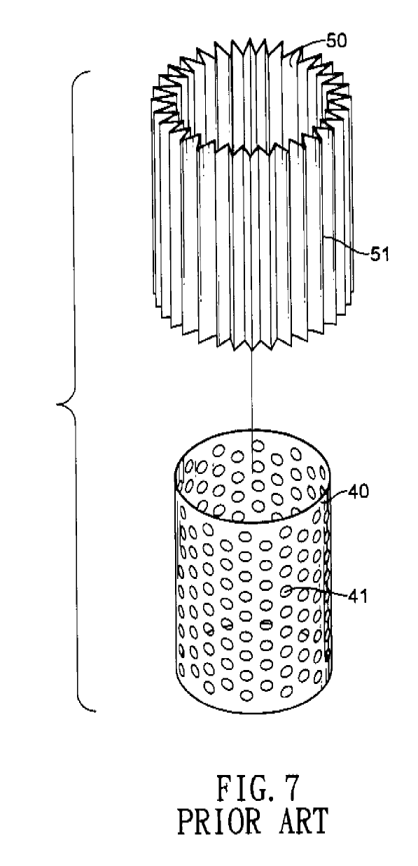

### DETAILED DESCRIPTION OF THE INVENTION

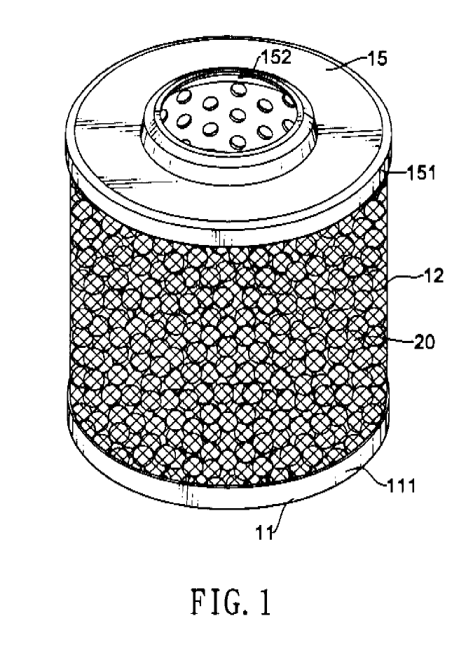

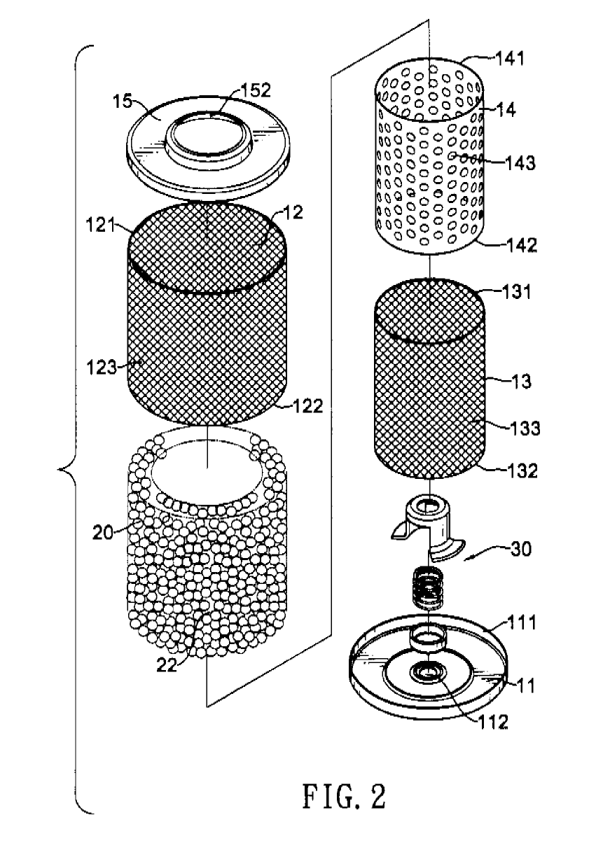

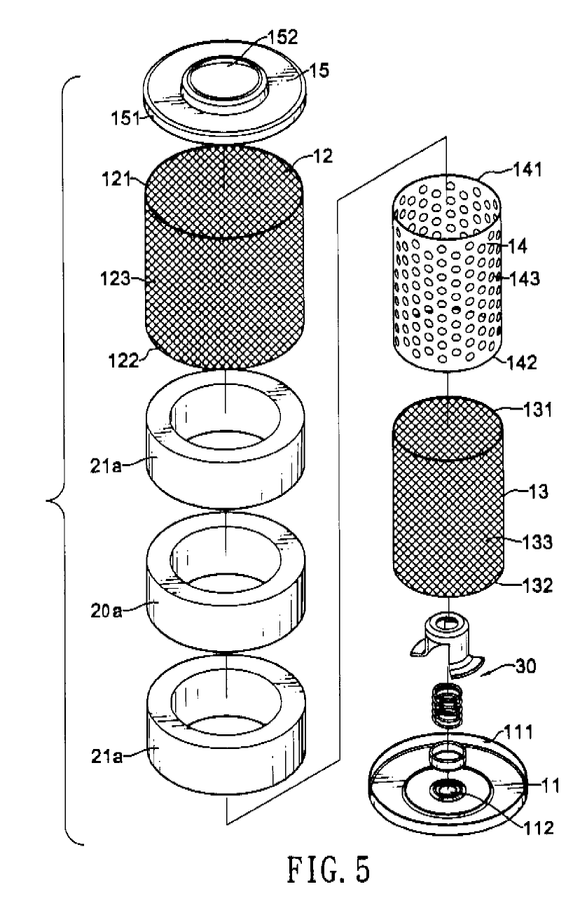

With reference to FIGS. 1, 2 and 5, a filter assembly in accordance with the present invention has a housing, and a filter and fastening assembly (30).

The housing has a base (11), an outer filter screen, (12), an inner filter screen (13), a metal net (14) and a cover (15).

The base (11) has a shape, an upper surfaces a sidewall (111), and a central hole (112). The shape of the base (11) is dish-like and may be circular The upper surface has an edge. The sidewall (11) is mounted on the edge of the upper surface. The central hole (12) is defined through a central part of the base (11).

The outer filter screen (12) is tubular, may be cylindrical, is fastened on the upper surface of the base (11) and has an inner surface, an upper edge (121), a lower edge (122), an outer surface and multiple grids (123). The lower edge (122) is fastened on the upper surface of the base (11). The outer surface near the lower edge (122) abuts the sidewall (111) of the base (11). The grids (123) are defined through the outer filter screen (12) and allow unfiltered fluid such as fuel oils, the lubricant and exhaust gas to flow into the filter assembly. The inner filter screen (13) is tubular, may be a cylindrical, is fastened on the upper surface of the base (11), is surrounded by the outer filter screen (12) and has an outer surface, an upper edge (131), a lower edge (132) and multiple grids (133). The lower edge (132) is fastened on the upper surface of the base (11). The grids (133) are defined through the inner filter screen (13) and allow a filtered fluid from the outer filter screen (12) to pass through the grids (133).

The metal net (14) is tubular, may be cylindrical, is fastened on upper surface of the base (11), is surrounded by the inner filter screen (13), surrounds the central hole (112) of the base (111) and has an upper edge (141), a lower edge (142) and multiple holes (143). The lower edge (142) is fastened on the upper surface of the base (11). The holes (143) are defined through the metal net (14) and allows the filtered fluid to pass through the holes (141).

The cover (15) is fastened on the upper edges (121, 131, 141) of the outer and inner filter screens (12, 13) and the metal net (14) and has a shape, a lower surface, a sidewall (151) and an outlet (152). The lower surface has an edge. The shape of the cover (15) corresponds to the shape of the base (11). The sidewall (151) is mounted on the edge of the lower surface and abuts the outer surface near the upper edge (121) of the outer filter screen (12). The outlet (152) is declined through the cover (15), is surrounded by the metal net (14) and allows the filtered fluid to flow out of the filter assembly.

The filter is mounted between the outer filter screen (12) and the inner filter screen (13) and abuts the inner surface of the outer filter screen (12) and the outer surface of the inner filter screen (13). The filter can be made of ceramic, mineral and metal.

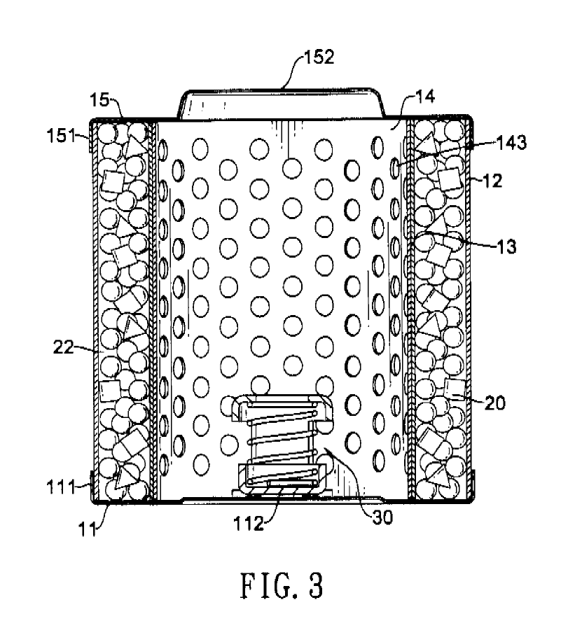

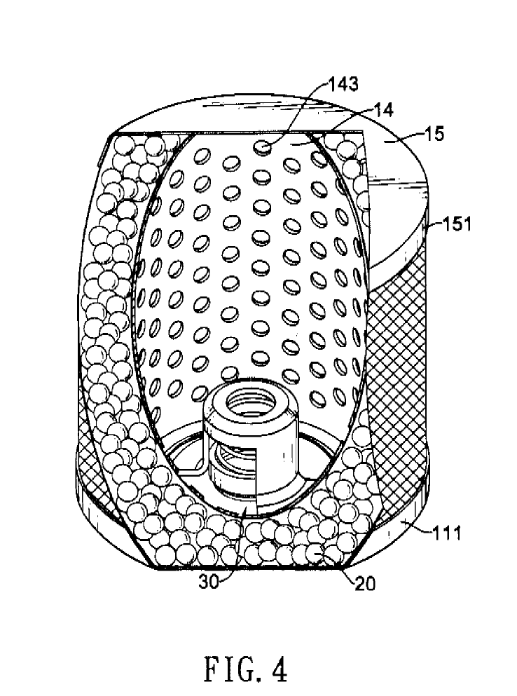

With further reference to FIGS. 3 and 4, in a first embodiment of the filter in accordance with the present invention, the filter has multiple elements (20). The elements (20) can be made of ceramics, minerals and metal. The elements (20) are contained in a space between the outer filter screen (12) and the inner filter screen (13) to define multiple intervals (22) that allow the unfiltered fluid to flow through the filter and each element (20) has a dimension and a shape. The dimensions of elements (20) can be varied to control the total area of the elements (20) contacting the unfiltered fluid. The shape of each element can be ball-shaped, polygonal or irregular to apply to different vehicles such as a trunk, bus, automobile, etc. Users can clean easily the filter by water or other solutions. Each ceramic element (20) is porous, is light and has multiple fine pores, corrosion resistance and heat resistance. The pores of the ceramic elements (20) also allow the unfiltered fluid to pass through the ceramic filter with the impurities being filtered and can even remove small impurities.

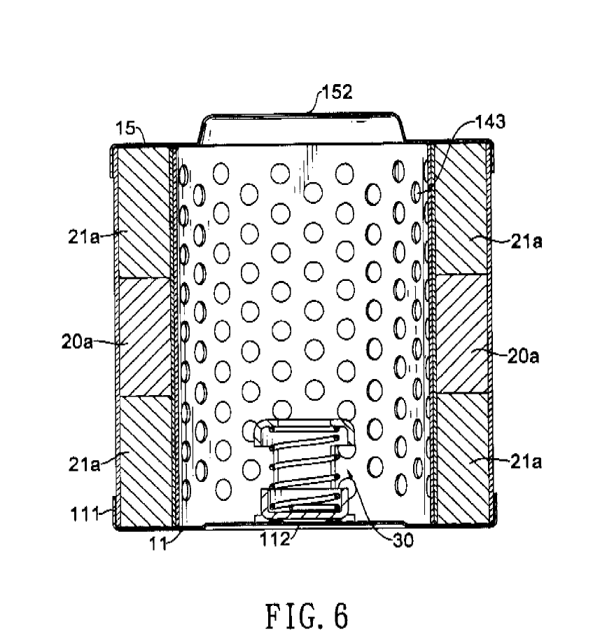

With further reference to FIG. 6, in a second embodiment of the filter in accordance with the present invention, the filter has at least one filter ring (20a) and at least one filter cotton (21a). The at least one filter ring (20a) is made of ceramics. The at least one filter cotton (21a) and the at least one filter ring (20a) are vertically stacked alternately in the space between the outer filter screen (12) and the inner filter screen (13). FIG. 6 shows that two filter cottons (21a) abut respectively the upper surface of the base (10) and the lower surface of the cover (15) and one filter ring (20a) is mounted between the filter cottons (21a).

The fastening assembly (30) fastens the housing in the automobile, such as in an internal combustion engine or in an exhaust pipe, to filter the unfiltered fluid and to remove impurities.

The unfiltered fluid will be filtered by the outer filter screen (12), the ceramic filter, the inner filter screen (13) and may be further filtered by the at least one filter cotton (21a), so the impurities will be removed clearly. When the filter assembly is mounted in the internal combustion engine, the filter assembly will filter the fuel oil and the lubricant to prevent a cylinder and a piston in the internal combustion engine from being rubbed by impurities. When the filter assembly is mounted in the the exhaust pipe, the filter assembly will filter exhaust gas to prevent the exhaust gas from polluting environment.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

1. A filter assembly comprising:
a housing having
a base;
an outer filter screen being tubular, fastened to the base and having multiple grids defined through the outer filter screen;
an inner filter screen being tubular, fastened to the base, surrounded by the outer filter screen and having multiple grids defined through the inner filter screen;
a metal net being tubular, fastened to the base, surrounded by the inner filter screen and having multiple holes defined through the metal net;
a cover fastened to the outer filter screen, the inner filter screen and the metal net and having
a shape corresponding to a shape of the base; and
an outlet defined through the cover, surrounded by the metal net; and
a filter mounted between the outer filter screen and the inner filter screen.

2. The filter assembly as claimed in claim 1, wherein:
the base is dish-like and has
an upper surface having an edge;
a sidewall mounted on the edge of the upper surface; and
a central hole defined through a central part of the base;
the outer filter screen further has
an inner surface;
an upper edge;
a lower edge fastened on the upper surface of the base; and
an outer surface abutting the side wall of the base;
the inner filter screen further has
an outer surface;
an upper edge; and
a lower edge fastened on the upper surface of the base;
the metal net surrounding the central hole of the base and further has
an upper edge; and
a lower edge fastened on the upper surface of the base;
the cover further has
a lower surface having an edge; and
a sidewall mounted on the edge of the lower surface and abutting the outer surface near the upper edge of the outer filter screen.

3. The filter assembly as claimed in claim 2, wherein the filter comprises multiple elements contained in a space between the outer filter screen and the inner filter screen to define multiple intervals.

4. The filter assembly as claimed in claim 2, wherein the filter has at least one filter ring being made of ceramics and at least one cotton filter element vertically stacked alternately in a space between the outer filter screen and the inner filter screen.

5. The filter assembly as claimed in claim 2, wherein the filter has
two cotton filter elements mounted in a space between the outer filter screen and the inner filter screen and pressing respectively against the upper surface of the base and the lower surface of the cover; and
a filter ring being made of ceramics and mounted between the cotton filter elements.

6. The filter assembly as claimed in claim 2, wherein
the shape of the base is circular;
the outer filter screen is cylindrical;
the inner filter screen is cylindrical;
the metal net is cylindrical; and
the shape of the cover being circular.

7. The filter assembly as claimed in claim 3, wherein the elements are made of ceramics.

8. The filter assembly as claimed in claim 3, wherein the elements are made of minerals.

9. The filter assembly as claimed in claim 3, wherein the elements are made of metal.

10. The filter assembly as claimed in claim 3, wherein each element is ball-shaped.

11. The filter assembly as claimed in claim 3, wherein each element has a polygonal shape.

12. The filter assembly as claimed in claim 3, wherein each element has an irregular shape.
